(19) United States
(12) Patent Application Publication
(10) Pub. No.: US 2025/0303569 A1
(43) Pub. Date: Oct. 2, 2025

(54) SYSTEM, UNIT, AND MANUFACTURING METHOD

(71) Applicant: KABUSHIKI KAISHA YASKAWA DENKI, Fukuoka (JP)

(72) Inventors: Takahiro MAEDA, Fukuoka (JP); Yuta ARITA, Fukuoka (JP); Motoharu MARUNO, Fukuoka (JP)

(21) Appl. No.: 19/086,177

(22) Filed: Mar. 21, 2025

(30) Foreign Application Priority Data
Mar. 27, 2024 (JP) 2024-050691

(51) Int. Cl. B25J 9/16

(52) U.S. Cl. CPC B25J 9/1666; B25J 9/162; B25J 9/1676

(57) ABSTRACT

Provide is a system including: a monitoring element which monitors a robot during runtime, based on a monitoring condition; and a path generation element which generates an operation path of the robot by using the monitoring condition used by the monitoring element. The path generation element may include information regarding an interference region in a vicinity of the robot, and the operation path may be generated by using the monitoring condition in addition to the interference region. The system may further include an interference region update element which updates the information regarding the interference region, based on real-time sensing information from a sensor, and the path generation element may generate the operation path by using the information, which is updated, regarding the interference region and the monitoring condition.

The contents of the following patent application(s) are incorporated herein by reference: NO. 2024-050691 filed in JP on Mar. 27, 2024.

### BACKGROUND

### 1. Technical Field

The present invention relates to a system, a unit, and a manufacturing method.

### 2. Related Art

Patent Document 1 describes a method of planning an operation route of a robot in which the robot and an obstacle in a work environment do not interfere with each other when a start and a goal arrangement of the robot are given by using a geometric model means on a computing device which describes geometric shapes and arrangement of the robot and the work environment and an interference inspection means on the computing device which inspects interference between models.

### PRIOR ART DOCUMENT

### Patent Document

Patent Document 1: Japanese Patent Application Publication No. 2000-020117

### BRIEF DESCRIPTION OF THE DRAWINGS

FIG. 1 schematically shows an example of a system 10.

FIG. 2 schematically shows another example of the system 10.

FIG. 3 schematically shows an example of an operation path 320 of a robot 20.

FIG. 4 schematically shows an example of the operation path 320 of the robot 20.

FIG. 5 is an explanatory diagram for explaining a merge region 432.

FIG. 6 schematically shows an example of the operation path 320 of the robot 20.

FIG. 7 schematically shows an example of an industrial robot 200 which is an example of the robot 20.

FIG. 8 schematically shows an example of a configuration of the system 10.

FIG. 9 schematically shows an example of a hardware configuration of a robot controller 30 and an autonomous control unit 36.

FIG. 10 schematically shows an example of a flow in which the system 10 performs manufacturing processing of an object to be manufactured.

FIG. 11 schematically shows another example of the configuration of the system 10.

FIG. 12 schematically shows an example of a system 50.

FIG. 13 schematically shows an example of a hardware configuration of a computer 1200 functioning as the robot controller 30, a robot control unit 32, a functional safety unit 34, the autonomous control unit 36, or a simulator 700.

### DESCRIPTION OF EXEMPLARY EMBODIMENTS

Hereinafter, embodiments of the present invention will be described. However, the following embodiments are not for limiting the invention according to the claims. In addition, not all combination of the features described in the embodiments are necessary for the solution of the invention.

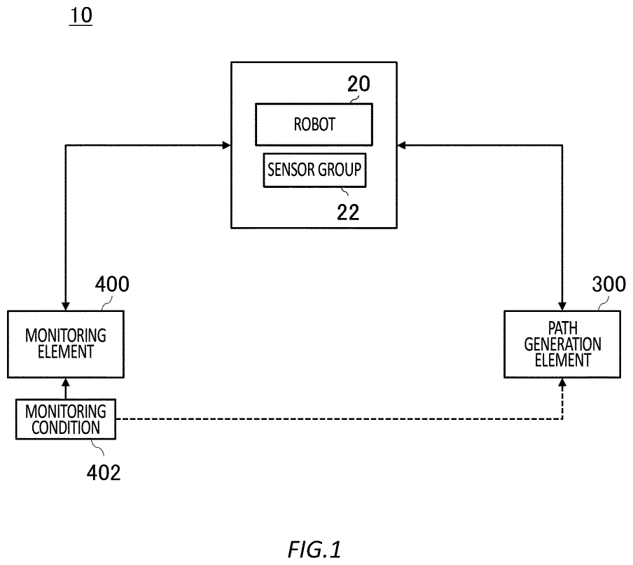

FIG. 1 schematically shows an example of a system 10. The system 10 includes a path generation element 300. The system 10 includes a monitoring element 400.

The system 10 may include a robot 20. The robot 20 is, for example, a playback robot.

The robot 20 may be an industrial robot. For example, the robot 20 is an articulated robot. For example, the robot 20 is a vertical articulated robot. The robot 20 may be a six-axis robot. The robot 20 may be a seven-axis robot. The robot 20 may be a five-axis robot. The robot 20 may be a four-axis robot. The robot 20 may be a horizontal articulated robot. The operation path of the robot 20 may represent a movement route of a part of the robot 20. For example, the operation path represents a movement route of a distal end portion of the robot 20. The distal end portion of the robot 20 may be, for example, a center of a flange surface of the robot 20.

The robot 20 may be a robot having a function of moving by itself. The robot 20 may be a robot that moves using wheels. The robot 20 may be a robot that moves using its legs. The operation path of the robot 20 may represent a movement route of the robot 20.

The system 10 may include a sensor group 22. The sensor group 22 includes a plurality of sensors. Each of the plurality of sensors performs sensing on the robot 20 and outputs sensing information. The sensor group 22 may include a sensor arranged inside the robot 20 or on an outer surface of the robot 20 and a sensor arranged outside the robot 20 to be separated from the robot 20. Examples of the sensor include a position sensor, a speed sensor, a force sensor, an acceleration sensor, a gyro sensor, a strain sensor, a pressure sensor, a distance measurement sensor, a vibration sensor, an imaging sensor, a sound collection sensor, a temperature sensor, a humidity sensor, and the like, but the sensor is not limited thereto.

The path generation element 300 generates an operation path of the robot 20. The path generation element 300 generates an operation path for causing the robot 20 to perform a predetermined operation. The path generation element 300 includes information regarding an interference region in a vicinity of the robot 20. The interference region may be a region where interference with the robot 20 is to be avoided. The interference region may be, for example, a region where an obstacle for the robot 20 is located. The interference region may be, for example, a region determined as a region where the interference with the robot 20 is not desired. The vicinity of the robot 20 may be within a predetermined range based on a position of the robot 20. The range may be, for example, a movable range of the robot 20. When the robot 20 can have an arbitrary tool attached to it, the range may be a movable range of the robot 20 including the tool attached to the robot 20. When the robot 20 can grip an arbitrary target object, the range may be a movable range of the robot 20 including the target object gripped by the robot 20.

The path generation element 300 may use the information regarding the interference region to generate the operation path of the robot 20 so as to avoid the interference region. The path generation element 300 may generate the operation path such that the robot 20 performs a predetermined operation while avoiding the interference region.

The monitoring element 400 monitors the robot 20 during runtime, based on a monitoring condition 402. The monitoring element 400 may monitor that the robot 20 satisfies the monitoring condition 402. When it is detected that the robot 20 does not satisfy the monitoring condition 402, the monitoring element 400 may execute control such as stopping the operation of the robot 20 or outputting a warning. For example, when it is detected that the robot 20 does not satisfy the monitoring condition 402, the monitoring element 400 stops power supply to the robot 20.

The monitoring condition 402 includes, for example, information regarding the interference region of the robot 20. The monitoring element 400 may monitor that the robot 20 does not interfere with the interference region. The monitoring condition 402 includes, for example, information regarding an operation region of the robot 20. The monitoring element 400 may monitor that the robot 20 does not leave the operation region. The monitoring condition 402 includes, for example, an upper limit value of a speed of the robot 20. The monitoring element 400 may monitor that the speed of the robot 20 does not exceed the upper limit value. These are examples, and the monitoring condition 402 may include information other than these.

When the path generation element 300 generates the operation path without considering the monitoring element 400, there is a possibility that the monitoring condition 402 is not satisfied when the robot 20 is operated according to the operation path. On the other hand, the path generation element 300 according to the present embodiment generates the operation path of the robot 20 by using the monitoring condition 402 used by the monitoring element 400.

When the monitoring element 400 stores the monitoring condition 402, the path generation element 300 may acquire the monitoring condition 402 from the monitoring element 400 and use the monitoring condition 402. The path generation element 300 may acquire the monitoring condition 402 from the monitoring element 400 by bus communication. The path generation element 300 may acquire the monitoring condition 402 from the monitoring element 400 via a communication cable. The path generation element 300 may acquire the monitoring condition 402 from the monitoring element 400 via a communication network. The path generation element 300 may acquire the monitoring condition 402 from the monitoring element 400 via another element. When the monitoring element 400 is used for monitoring with reference to the monitoring condition 402 in a memory arranged outside the monitoring element 400, the path generation element 300 may be used with reference to the monitoring condition 402 in the memory.

The path generation element 300 generates the operation path of the robot 20 by using the monitoring condition 402 in addition to the interference region. The path generation element 300 generates the operation path such that the robot 20 satisfies the monitoring condition 402. As a specific example, when the monitoring condition 402 includes the information regarding the interference region of the robot 20, the path generation element 300 generates the operation path such that the robot 20 does not interfere with an interference region indicated by the information regarding the interference region included in the monitoring condition 402.

When the monitoring element 400 determines that the monitoring condition 402 is not satisfied, the monitoring element 400 executes some response processing, so that an original operation of the robot 20 may be stopped or delayed. According to the path generation element 300 according to the present embodiment, a possibility of occurrence of such a situation can be reduced, and thus it is possible to contribute to maintaining a throughput of the robot 20 or the like. When a user who uses the system 10 is, for example, a manufacturer who manufactures a product or the like by robot control, even a temporary stop in a manufacturing operation by the robot 20 may result in a considerable disadvantage for the user. According to the system 10, it is possible to reduce a possibility of occurrence of the disadvantage for the user.

When the monitoring element 400 has a function of performing an emergency stop on the robot 20 if the monitoring condition 402 is no longer satisfied, the robot 20 may be damaged due to the emergency stop. When the robot 20 is damaged, a possibility of occurrence of a malfunction in the operation of the robot 20, occurrence of a malfunction in a processing target of the robot 20, or shortening of a life of the robot 20 is increased, which may result in a considerable disadvantage for the user, but according to the system 10, a possibility of occurrence of the disadvantage for the user can be reduced.

The monitoring element 400 may have a function of using a plurality of monitoring conditions 402 while switching between the monitoring conditions 402. The plurality of monitoring conditions 402 may include a plurality of monitoring conditions 402 of a same type but different contents. For example, the plurality of monitoring conditions 402 includes a plurality of monitoring conditions 402 including information regarding different interference regions. The plurality of monitoring conditions 402 may include a plurality of monitoring conditions 402 of different types. For example, the plurality of monitoring conditions 402 include a monitoring condition 402 including the information regarding the interference region and a monitoring condition 402 including the upper limit value of the speed.

For example, monitoring element 400 switches the monitoring condition 402 in response to an instruction from an operator of the system 10. For example, the monitoring element 400 switches the monitoring condition 402 according to a work content of the robot 20. The monitoring element 400 may switch the plurality of monitoring conditions 402 based on the sensing information from the sensor included in the sensor group 22. For example, the monitoring element 400 uses different monitoring conditions 402 depending on whether the sensor included in the sensor group 22 determines that a person is present in the vicinity of the robot 20 or determines that no person is present in the vicinity of the robot 20.

The path generation element 300 may generate the operation path by using the monitoring condition 402, which is used by the monitoring element 400 when generating the operation path of the robot 20, among the plurality of monitoring conditions 402. The path generation element 300 may acquire the monitoring condition 402, which is used by the monitoring element 400 when generating the operation path of the robot 20, among the plurality of monitoring conditions 402, and generate the operation path by using the acquired monitoring condition 402. The path generation element 300 may determine the monitoring condition 402 to be used, by acquiring the plurality of monitoring conditions 402 in advance and acquiring, from the monitoring element 400, information indicating which monitoring condition 402 is the monitoring condition 402 used by the monitoring element 400 when generating the operation path.

If the monitoring element 400 has a function using the plurality of monitoring conditions 402 while switching between the monitoring conditions 402, when the monitoring condition 402 used by the monitoring element 400 is switched after the path generation element 300 acquires the monitoring condition 402 used by the monitoring element 400, the monitoring condition 402 of the monitoring element 400 is different from the monitoring condition 402 considered by the path generation element 300. In this case, the operation path generated by the path generation element 300 may result in not satisfying the monitoring condition 402. According to the system 10 according to the present embodiment, the monitoring condition 402 considered by the path generation element 300 can be matched with the monitoring condition 402 currently used by the monitoring element 400.

The path generation element 300 and the monitoring element 400 may be mounted in different units. The unit may be, for example, a computing device that has a configuration such as a CPU and a memory and is independently operable. For example, the path generation element 300 is implemented by a processing section mounted on a first unit, and the monitoring element 400 is implemented by a processing section mounted on a second unit different from the first unit. The processing section may be one or more processors. The processing section may be a central processing unit (CPU) or may be a multi-CPU.

The path generation element 300 and the monitoring element 400 may be mounted in one unit. For example, the path generation element 300 is implemented by a first processing section mounted on the corresponding unit, and the monitoring element 400 is implemented by a second processing section mounted on the corresponding unit. The first processing section may be one or more processors. The second processing section may be one or more processors. The first processing section and the second processing section may be CPUs or multi-CPUs.

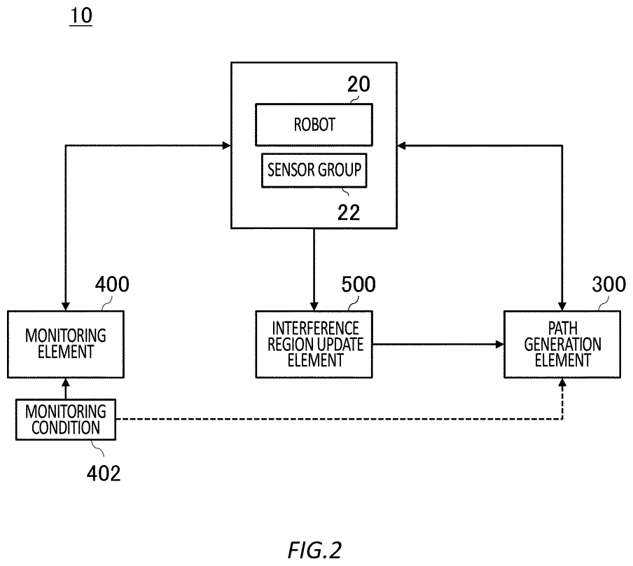

FIG. 2 schematically shows another example of the system 10. Here, differences from the system 10 shown in FIG. 1 will be mainly described. The system 10 illustrated in FIG. 2 further includes an interference region update element 500.

The interference region update element 500 updates the information regarding the interference region of the robot 20 included in the path generation element 300, based on real-time sensing information from the sensor included in the sensor group 22. The interference region update element 500 updates the information regarding the interference region of the robot 20, for example, by analyzing a captured image captured by an imaging sensor that images the vicinity of the robot 20. The interference region update element 500 may update the information regarding the interference region of the robot 20, for example, by using another sensor such as a distance measurement sensor or by using a plurality of sensors in combination.

The interference region update element 500 provides the updated information regarding the interference region to the path generation element 300. For example, when a shape of the interference region changes, the interference region update element 500 updates the information regarding the interference region and provides the updated information to the path generation element 300. For example, when the interference region increases, the interference region update element 500 updates the information regarding the interference region and provides the updated information to the path generation element 300. For example, when the interference region disappears, the interference region update element 500 updates the information regarding the interference region and provides the updated information to the path generation element 300. The path generation element 300 may generate the operation path of the robot 20 by using the updated information regarding the interference region and the monitoring condition 402.

A path planning function of generating the operation path of the robot 20 based on the real-time sensing information from the sensor is known. When the path generation element 300 has the path planning function, if the monitoring condition 402 is not considered when generating the operation path in real time, an obstacle detected by the real-time sensing can be avoided, but at that time, a situation may occur in which the monitoring condition 402 is not satisfied. On the other hand, when the interference region update element 500 updates the information regarding the interference region, the path generation element 300 generates the operation path by using the updated information regarding the interference region and the monitoring condition 402, so that the obstacle detected by the real-time sensing can be avoided, and the operation path satisfying the monitoring condition can be generated in real time.

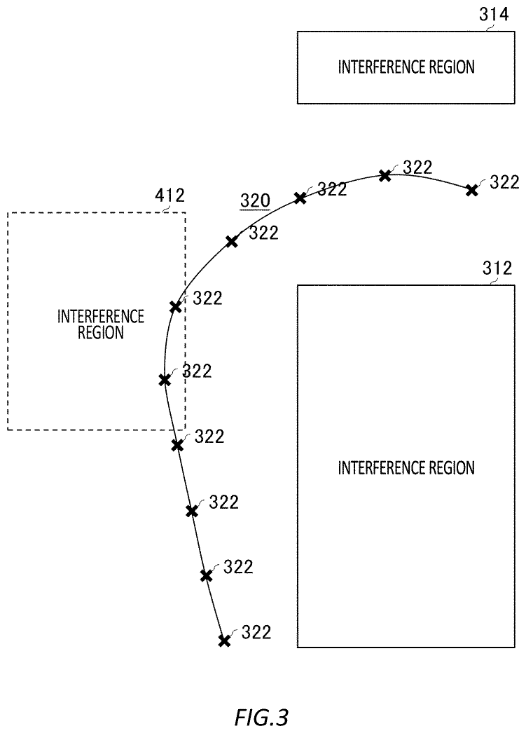

FIG. 3 is an explanatory diagram for conceptually explaining an operation path 320 generated by the path generation element 300. In the example shown in FIG. 3, the information regarding the interference region included in the path generation element 300 includes region information regarding the interference region 312 and the interference region 314. Here, a case is illustrated in which the path generation element 300 generates the operation path 320 without considering the monitoring condition 402 including the information regarding the interference region 412 of the robot 20.

The path generation element 300 generates the operation path 320 including a plurality of segments separated by a plurality of via points 322. Each of the plurality of segments is between two via points 322. The via point 322 defines at least a position of the robot 20. When the robot 20 is an industrial robot, the position of the robot 20 may be a position of the distal end portion of the robot 20, such as the center of the flange surface of the robot 20. The via point 322 may define the position and a posture of the robot 20. The via point 322 may include information regarding a moving speed of the robot 20.

As a specific example, the path generation element 300 first interpolates a start point and an arrival point with a straight line to temporarily generate the operation path 320, and simulates the operation of the robot 20 based on the temporarily generated operation path 320 to check whether or not the robot 20 interferes with the interference region 312 and the interference region 314. For example, the path generation element 300 may store model information of the robot 20 in advance, simulate the operation of the robot 20 by using the model information, and check whether or not the robot 20 interferes with the interference region 312 and the interference region 314. The model information may include numerical information specifying a structure and a size. When it is determined that the robot 20 interferes with the interference region 312 or the interference region 314, the path generation element 300 randomly generates one via point 322 that does not cause the interference with the interference region 312 and the interference region 314, and adds the via point between the start point and the arrival point. Thereafter, the generation and addition of the via point 322 are repeated until the operation path 320 connecting the start point, the generated one or more via points, and the arrival point no longer causes the interference between the robot 20 and the interference region 312 and the interference region 314. Accordingly, it is possible to generate the operation path 320 that does not cause the interference with the interference region 312 and the interference region 314.

As shown in FIG. 3, when the path generation element 300 does not consider the monitoring condition 402, as a result, the operation path 320 can be generated which can avoid the interference region 312 and the interference region 314 but interferes with the interference region 412. When the robot 20 is operated according to the operation path 320 illustrated in FIG. 3, the monitoring condition 402 is not satisfied, and the robot 20 is emergency-stopped by the monitoring element 400.

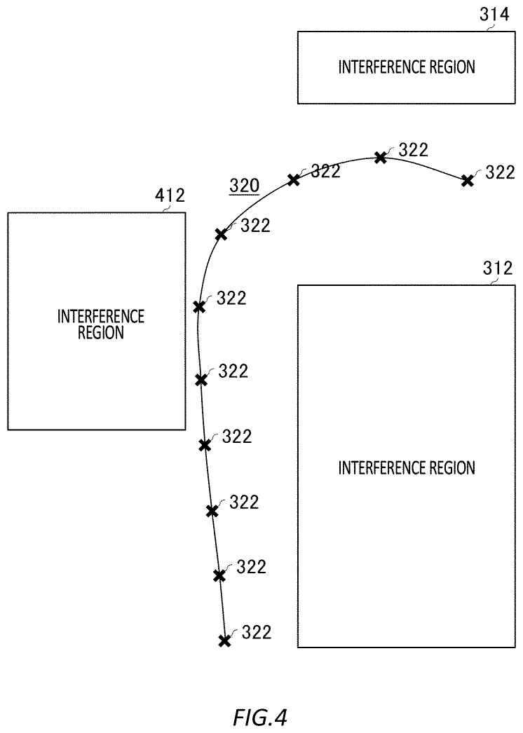

FIG. 4 is an explanatory diagram for conceptually explaining the operation path 320 generated by the path generation element 300. Differences from FIG. 3 will be mainly described. Here, a case is illustrated in which the path generation element 300 generates the operation path 320 in consideration of the monitoring condition 402 including the information regarding the interference region 412 of the robot 20.

As a specific example, the path generation element 300 first interpolates the start point and the arrival point with a straight line to temporarily generate the operation path 320, and simulates the operation of the robot 20 based on the temporarily generated operation path 320 to check whether or not the robot 20 interferes with the interference region 312 and the interference region 314 and whether or not the robot 20 interferes with the interference region 412. When it is determined that the robot 20 interferes with at least one of the interference region 312, the interference region 314, or the interference region 412, the path generation element 300 randomly generates one via point 322 that is not included in the interference region 312, the interference region 314, and the interference region 412, and adds the via point between the start point and the arrival point. Thereafter, the generation and addition of the via point 322 are repeated until the operation path 320 connecting the start point, the generated one or more via points, and the arrival point no longer causes the interference between the robot 20 and the interference region 312, the interference region 314, and the interference region 412. Accordingly, as shown in FIG. 4, the path generation element 300 can generate the operation path 320 such that the robot 20 does not interfere with the interference region 312, the interference region 314, and the interference region 412.

When the interference region 412 is included in the monitoring condition 402, even if the user can set the interference region 412 for the path generation element 300 later, a burden to make settings is placed on the user. In addition, when the user makes a setting mistake, there is a possibility that the operation path 320 on which the robot 20 interferes with the interference region is generated, and this case results in the monitoring condition 402 not being satisfied in the monitoring element 400. On the other hand, the path generation element 300 according to the present embodiment acquires the information regarding the interference region 412 included in the monitoring condition 402 of the monitoring element 400 and uses the information regarding the interference region 412, so that the operation path 320 in which a condition regarding the interference region 412 is satisfied can be generated without placing the burden on the user.

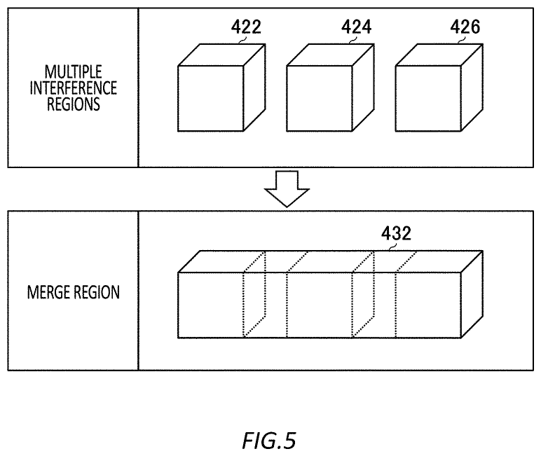

FIG. 5 is an explanatory diagram for explaining a merge region 432. When a plurality of interference regions are included in the monitoring condition 402, the path generation element 300 may specify a merge region including the plurality of interference regions and generate the operation path 320 such that the robot 20 does not interfere with the specified merge region. For example, the path generation element 300 may specify, as the merge region, a smallest region including all of the plurality of interference regions included in the monitoring condition 402.

FIG. 5 illustrates a case where the monitoring condition 402 includes an interference region 422, an interference region 424, and an interference region 426 each having a rectangular parallelepiped shape. The path generation element 300 may specify a merge region 432 having a rectangular parallelepiped shape and including the interference region 422, the interference region 424, and the interference region 426. Accordingly, a calculation cost can be reduced as compared with a case where the operation path 320 is generated for each of the three interference regions such that the robot 20 does not interfere. If the path generation element 300 generates the operation path 320 during runtime and the monitoring condition 402 includes a plurality of interference regions, when calculation is performed for all the interference regions, a delay may occur and efficient robot control may not be performed. On the other hand, the delay can be reduced by specifying a merge region and performing calculation only for the merge region.

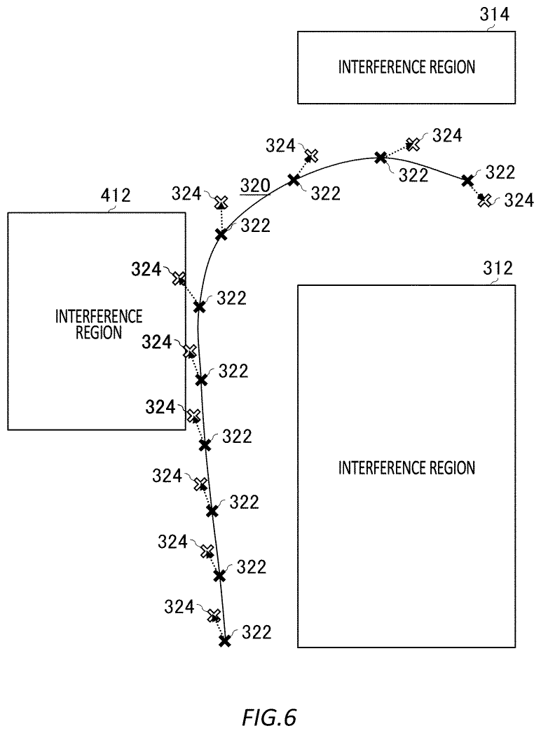

FIG. 6 is an explanatory diagram for conceptually explaining the operation path 320 generated by the path generation element 300. Here, a case will be explained in which the robot 20 is a robot that is motor-driven like an industrial robot, and the monitoring condition 402 includes coasting amount information regarding a coasting amount of the robot 20 when power supply to a motor of the robot 20 is shut off during the operation of the robot 20.

The monitoring element 400 may have a safety function in which a position that the robot 20 reaches by coasting when the power supply to the motor of the robot 20 is shut off at a future timing of the robot 20 is predicted based on a value related to the robot 20 and the coasting amount information, and the power supply to the motor of the robot 20 is shut off when the predicted position is included in the interference region 412. The value related to the robot 20 may be a value of feedback from the robot 20. The value related to the robot 20 may be a value sensed by the sensor group 22. For example, the monitoring element 400 predicts a position of the robot 20 at each future timing of the robot 20 based on at least one of the value of the feedback from the robot 20 or the value sensed by the sensor group 22, adds the coasting amount indicated by the coasting amount information to each position to predict a position that the robot 20 reaches by coasting when the power supply to the motor of the robot 20 is shut off at each position, and shuts off the power supply to the motor of the robot 20 when the predicted position is included in the interference region 412.

Even when the path generation element 300 generates the operation path 320 that does not cause the interference with the interference region 412, if the monitoring element 400 has the safety function and the operation path 320 is determined in consideration of the coasting amount to cause the robot 20 to interfere with the interference region 412, the power supply to the motor of the robot 20 is shut off by the monitoring element 400. A coasting position 324 in FIG. 6 indicates a position to which the robot 20 coasts when the power supply to the motor of the robot 20 is shut off at the via point 322. As shown in FIG. 6, even when the operation path 320 itself does not cause the interference with the interference region 412, the coasting position 324 may be included in the interference region 412. In this case, the operation of the robot 20 is stopped by the safety function of the monitoring element 400.

On the other hand, the path generation element 300 may generate the operation path 320 such that, at each timing of the operation path 320, the position that the robot 20 reaches by coasting when the power supply to the motor of the robot 20 is shut off is not included in the interference region 412. For example, the path generation element 300 generates the operation path 320 such that the coasting position 324 that the robot 20 reaches by coasting when the power supply to the motor of the robot 20 is shut off at each of the plurality of via points 322 of the operation path 320 is not included in the interference region 412. The path generation element 300 may generate such an operation path 320 by adjusting positions of the plurality of via points 322.

As a specific example, the path generation element 300 first interpolates the start point and the arrival point with a straight line to temporarily generate the operation path 320, and simulates the operation of the robot 20 based on the temporarily generated operation path 320 to check whether or not the robot 20 interferes with the interference region 312 and the interference region 314 and whether or not the robot 20 interferes with the interference region 412. When it is determined that the robot 20 interferes with at least one of the interference region 312, the interference region 314, or the interference region 412, the path generation element 300 randomly generates one via point 322 that does not cause the interference with the interference region 312, the interference region 314, and the interference region 412 when coasting, and adds the via point between the start point and the arrival point. Thereafter, the generation and addition of the via point 322 are repeated until the operation path 320 connecting the start point, the generated one or more via points, and the arrival point no longer causes, even when coasting, the interference between the robot 20 and the interference region 312, the interference region 314, and the interference region 412.

Accordingly, it is possible to generate the operation path 320 capable of implementing the operation satisfying the monitoring condition 402. Note that, by using a fact that a coasting distance can be shortened by reducing a speed at the via point 322, the path generation element 300 may adjust speeds at the plurality of via points 322 to generate the operation path 320 such that the coasting position 324 that the robot 20 reaches by coasting when the power supply to the motor of the robot 20 is shut off is not included in the interference region 412.

The path generation element 300 may generate the operation path 320 by adjusting both the position of the via point 322 and the speed at the via point 322. In this case, the path generation element 300 may generate the operation path 320 by prioritizing adjustment of the position of the via point 322 over adjustment of the speed at the via point 322. Accordingly, it is possible to suppress a decrease in a throughput of the operation of the robot 20.

The path generation element 300 may generate the operation path 320 without considering the coasting amount information, and adjust the speed of the robot 20 by using the coasting amount information during control of the robot 20 using the operation path 320, thereby ensuring that the position after coasting does not cause the interference with the interference region.

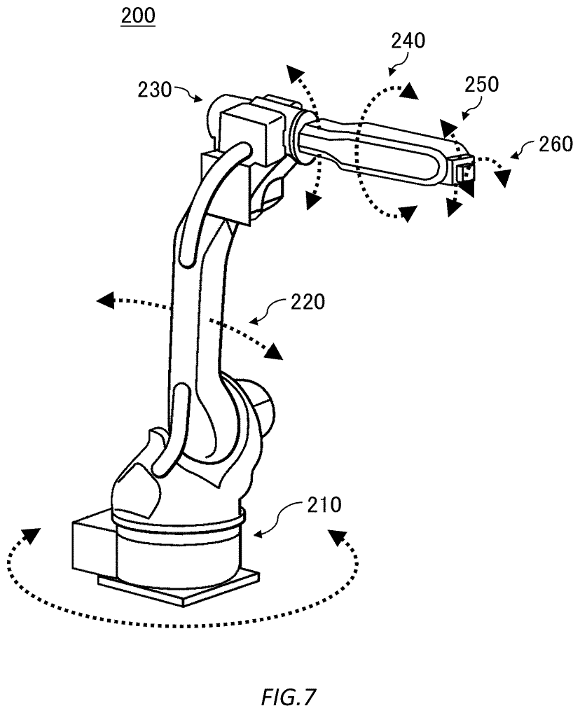

FIG. 7 schematically shows an example of an industrial robot 200 which is an example of the robot 20. The industrial robot 200 illustrated here is a six-axis robot. The industrial robot 200 includes a swing(S) axis 210, a lower arm (L) axis 220, an upper arm (U) axis 230, a wrist rotation (R) axis 240, a wrist bending (B) axis 250, and a wrist turning (T) axis 260.

A servomotor and a speed reducer are connected to each of the S axis 210, the L axis 220, the U axis 230, the R axis 240, the B axis 250, and the T axis 260. As shown in FIG. 7, the S axis 210 is an axis for turning a body of the industrial robot 200, the L axis 220 is an axis for moving the body of the industrial robot 200 back and forth, the U axis 230 is an axis for moving an arm of the industrial robot 200 up and down, the R axis 240 is an axis for rotating the arm of the industrial robot 200, the B axis 250 is an axis for swinging a wrist of the industrial robot 200 up and down, and the T axis 260 is an axis for rotating the wrist of the industrial robot 200.

Various tools are attached to the wrist of the industrial robot 200. Examples of the tool include a hand, a welding torch, a spot gun, and the like, but the tool is not limited thereto.

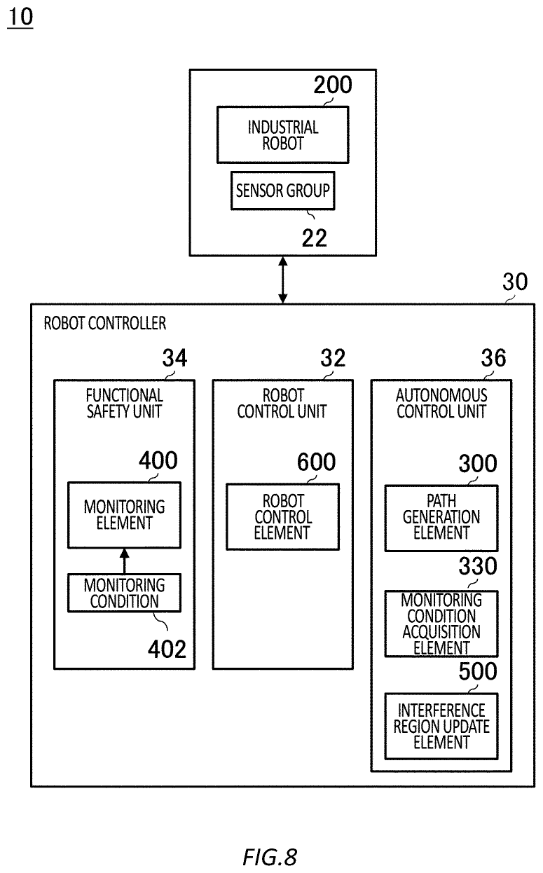

The system 10 according to the present embodiment may implement a function of executing path planning in consideration of a monitoring condition of a functional safety function. The functional safety function may be a function of shutting off the power supply to the motor of the robot to stop the robot when a preset monitoring condition is not satisfied. FIG. 8 schematically shows an example of the system 10. The system 10 shown in FIG. 8 includes a robot controller 30 that controls the industrial robot 200. The robot controller 30 includes a robot control unit 32, a functional safety unit 34, and an autonomous control unit 36.

### (Robot Control Unit 32)

The robot control unit 32 includes a robot control element 600. The robot control element 600 executes control of the industrial robot 200. The robot control element 600 may create an order for the industrial robot 200 or control the entire robot controller 30.

### (Functional Safety Unit 34)

The functional safety unit 34 includes the monitoring element 400. The monitoring element 400 has a functional safety function. The functional safety unit 34 includes the monitoring condition 402.

### (Functional Safety Function)

Table 1 below shows an example of the functional safety function and the monitoring condition 402 of the monitoring element 400.

TABLE 1

| FUNCTIONAL SAFETY FUNCTION | SETTINGS |
|---|---|
| EACH-AXIS | S AXIS: UPPER LIMIT VALUE, LOWER LIMIT VALUE |
| OPERATION-REGION | L AXIS: UPPER LIMIT VALUE, LOWER LIMIT VALUE |
| LIMITATION | . |
| | . |
| | . |
| EACH-AXIS SPEED MONITORING | S AXIS: UPPER LIMIT VALUE |
| | L AXIS: UPPER LIMIT VALUE |
| | . |
| | . |
| | . |
| OUT-OF-REGION MONITORING | PROHIBITED REGION A: REGION INFORMATION |
| | PROHIBITED REGION B: REGION INFORMATION |
| | . |
| | . |
| | . |
| IN-REGION MONITORING | REGION INFORMATION |
| PLANE MONITORING | PLANE INFORMATION |
| SPEED LIMITATION | TCP SPEED: UPPER LIMIT VALUE |
| | FCP SPEED: UPPER LIMIT VALUE |
| TOOL ANGLE MONITORING | TOOL A: REFERENCE VALUE, LIMIT ANGLE |
| | TOOL B: REFERENCE VALUE, LIMIT ANGLE |
| | . |
| | . |
| | . |

.
.
.

The functional safety function may include each-axis operation-region limitation. The each-axis operation-region limitation may be a function of setting an operation range (upper limit value and lower limit value) of each axis of the industrial robot 200 and monitoring that each axis does not move out of the set range. For example, for each axis, the monitoring element 400 predicts a future position, and shuts off power supply to a motor of the industrial robot 200 when it is determined that the predicted position is outside the set range. For example, for each axis, the monitoring element 400 predicts, from an operation speed, a coasting amount in a case of immediately stopping, and monitors to ensure that the future position considering the coasting amount does not exceed a safety range defined by the upper limit value and the lower limit value. When it is predicted that the future position considering the coasting amount exceeds the safety range in a case of an emergency stop, the monitoring element 400 shuts off the power supply to the motor of the industrial robot 200 at a timing to prevent exceeding the safety range.

The functional safety function may include each-axis speed monitoring. The each-axis speed monitoring may be a function of setting an upper limit value of the operation speed of each axis of the industrial robot 200 and monitoring that each axis does not exceed the set upper limit value. For example, for each axis, when it is predicted that the operation speed exceeds the upper limit value, the monitoring element 400 shuts off the power supply to the motor of the industrial robot 200.

The functional safety function may include out-of-region monitoring. The out-of-region monitoring may be a function of setting an interference region of the industrial robot 200 and monitoring that the industrial robot 200 does not interfere with the set interference region. The interference region may be set by a rectangular parallelepiped. The interference region may be set by a polygonal prism. The interference region may be set by another shape. For example, the monitoring element 400 predicts a future position that the industrial robot 200 reaches, and shuts off the power supply to the motor of the industrial robot 200 when the predicted position is included in the interference region. For example, the monitoring element 400 predicts a position that the industrial robot 200 reaches by coasting when the power supply to the motor of the industrial robot 200 is shut off at a future timing of the industrial robot 200, and shuts off the power supply to the motor of the industrial robot 200 when the predicted position is included in the interference region. As a specific example, the monitoring element 400 may predict whether or not the industrial robot 200 interferes with the interference region by specifying each joint position in a three-dimensional space according to a link length of the industrial robot 200 or the like, calculating a robot region by connecting the joint positions by a model (cylinder or the like) of the industrial robot 200, and comparing the robot region with the interference region.

The functional safety function may include in-region monitoring. The in-region monitoring may be a function of setting an operation region of the industrial robot 200 and monitoring that the industrial robot 200 is located within the set operation region. The operation region may be set by a rectangular parallelepiped. The operation region may be set by a polygonal prism. The operation region may be set by another shape. For example, the monitoring element 400 predicts a future position that the industrial robot 200 reaches, and shuts off the power supply to the motor of the industrial robot 200 when the predicted position is located outside the operation region. For example, the monitoring element 400 predicts a position that the industrial robot 200 reaches by coasting when the power supply to the motor of the industrial robot 200 is shut off at a future timing of the industrial robot 200, and shuts off the power supply to the motor of the industrial robot 200 when the predicted position is located outside the operation region.

The functional safety function may include plane monitoring. In the plane monitoring, a straight line is drawn with respect to any one of coordinate planes XY, YX, and ZX in a space where the industrial robot 200 is located, a plane (wall) is set in a vertical direction of each coordinate plane along the straight line, and a region on a side where the industrial robot 200 is present is defined as a safety region with respect to the set plane. For example, the monitoring element 400 predicts a future position that the industrial robot 200 reaches, and when the predicted position is located outside the safety region, the monitoring element 400 that shuts off the power supply to the motor of the industrial robot 200 predicts, for example, a position that the industrial robot 200 reaches by coasting when the power supply to the motor of the industrial robot 200 is shut off at a future timing of the industrial robot 200, and shuts off the power supply to the motor of the industrial robot 200 when the predicted position is located outside the safety region.

The functional safety function may include speed limitation. The speed limitation may be a function of setting upper limit values of a control point (Tool Center Point (TCP)) speed of the industrial robot 200 and a center point (Flange Center Point (FCP)) speed of a flange surface of the industrial robot 200 and monitoring that the speed of each point does not exceed the set upper limit value. For example, for each of the TCP and the FCP, the monitoring element 400 monitors the speed based on a feedback value from the industrial robot 200 and the sensing information of the sensor included in the sensor group 22, and shuts off the power supply to the motor of the industrial robot 200 when it is predicted that the speed exceeds the upper limit value.

The functional safety function may include tool angle monitoring. The tool angle monitoring may be a function of setting a reference value and a limit angle of an inclination of a tool attached to the industrial robot 200 and monitoring that an angle of the tool relative to the reference value does not operate beyond the set limit angle. For example, the monitoring element 400 monitors the inclination of the tool relative to the reference value, based on the feedback value from the industrial robot 200 or the sensing information of a sensor included in the sensor group 22, and shuts off the power supply to the motor of the industrial robot 200 when it is predicted that the inclination of the tool exceeds the set limit angle.

### (Autonomous Control Unit)

The autonomous control unit 36 includes the path generation element 300. The path generation element 300 may have the path planning function. The autonomous control unit 36 may include a monitoring condition acquisition element 330. The autonomous control unit 36 may include the interference region update element 500.

### (Generation of Operation Path)

The path generation element 300 includes information regarding an interference region in a vicinity of the industrial robot 200, and generates an operation path of the industrial robot 200 by using the monitoring condition 402 in addition to the interference region. The robot control element 600 may operate the industrial robot 200 according to the operation path generated by the path generation element 300. Note that the autonomous control unit 36 may issue a movement instruction to the robot controller 30 or issue a movement instruction to the industrial robot 200 based on the operation path generated by the path generation element 300.

The path generation element 300 may be used with reference to the monitoring condition 402 included in the functional safety unit 34. The path generation element 300 may use the monitoring condition 402 acquired by the monitoring condition acquisition element 330. The monitoring condition acquisition element 330 may acquire the monitoring condition 402 from the functional safety unit 34. The monitoring condition acquisition element 330 may directly acquire the monitoring condition 402 from the functional safety unit 34. When the monitoring condition acquisition element 330 cannot acquire the monitoring condition 402 directly from the functional safety unit 34, the monitoring condition acquisition element 330 may acquire the monitoring condition 402 via the robot control unit 32. The path generation element 300 may have a function of the monitoring condition acquisition element 330, and the path generation element 300 itself may acquire the monitoring condition 402.

Note that the monitoring condition 402 may be arranged outside the functional safety unit 34. For example, the monitoring condition 402 may be arranged in a memory or another unit included in the robot controller 30. In this case, the monitoring element 400 and the path generation element 300 may be used with reference to the monitoring condition 402 arranged in the memory or the another unit. The monitoring condition 402 may be arranged in the robot control unit 32. In this case, the monitoring element 400 and the path generation element 300 may be used with reference to the monitoring condition 402 arranged in the robot control unit 32.

### (Use of Monitoring Condition in Path Planning Function)

The interference region update element 500 updates information regarding the interference region of the industrial robot 200 included in the path generation element 300, based on the real-time sensing information from the sensor included in the sensor group 22. The path generation element 300 may generate the operation path of the industrial robot 200 by using the information regarding the interference region updated by the interference region update element 500 and the monitoring condition 402.

In the present example, the path generation element 300 may generate the operation path 320 including a plurality of predefined segments and one or more undefined segments. Each of the plurality of predefined segments is a segment, between two via points 322, in which a movement route is defined. Each of the one or more undefined segments is a segment, between two via points 322, in which a movement route is not defined.

For the one or more undefined segments, the path generation element 300 generates an operation path (may be described as an additional path) by using the information regarding the interference region updated in real time by the interference region update element 500 and the monitoring condition 402. The additional path represents a movement route between two via points 322 in the undefined segment.

The robot controller 30 executes sequentially issuing a plurality of commands, generating an additional path for each of one or more undefined segments, and operating the industrial robot 200 based on the issued command and the additional path. While operating the industrial robot 200 based on one command, the robot controller 30 updates the interference region in real time to generate the additional path.

The robot controller 30 may acquire the plurality of commands from an outside. The robot controller 30 may store the plurality of commands in advance. For example, the robot controller 30 stores in advance an operation program in which the plurality of commands is arranged in execution order.

As an example, the plurality of commands includes a move command and an auto command. The plurality of commands may include a plurality of move commands and one or more auto commands.

The move command includes information regarding a via point of the operation path of the industrial robot 200. The via point defines at least a position of a distal end portion of the industrial robot 200. The distal end portion of the industrial robot 200 may be, for example, a center of a flange surface of the industrial robot 200. The via point may define the position and a posture of the distal end portion. The via point may define an angle of each axis of the industrial robot 200 instead of defining the position and the posture of the distal end portion itself. The position and the posture of the distal end portion are also defined by defining the angle of each axis of the industrial robot 200. A via point of the move command may be a teaching point taught through off-line teaching by the operator, online teaching, or the like.

The move command may further include path specifying information. The path specifying information is information for specifying a path of a segment up to the via point of the move command and setting the segment as the predefined segment. The segment up to the via point of the move command may be described as a “move segment”. The path of the move segment may be may be described as a “move segment path”. For example, the path specifying information represents a path specifying condition that uniquely defines the move segment path. Examples of a specific example of the path specifying condition include interpolating the move segment with a straight line (linear interpolation), interpolating the move segment with an S-shaped curve (S-shaped interpolation), and the like.

Each of the one or more auto commands includes information regarding a via point of the operation path, which serves as an arrival point of the undefined segment. Each of the one or more auto commands may further include condition information that represents a generation condition when the additional path is generated. Examples of a specific example of the generation condition include a path specifying condition for an additional command to be described later, a condition of a moving speed in the additional path, a condition of an acceleration in the additional path, a condition of a deceleration in the additional path, a condition of the posture of the distal end portion in the additional path, a condition of whether or not to permit reuse of the generated additional path when there is no change in the interference region, and the like. Similarly to the via point of the move command, a via point of the auto command may be a teaching point taught through off-line teaching by the operator, online teaching, or the like.

Examples of the move command include MoveL, MoveS, and MoveJ. MoveL indicates that the position and the posture of the distal end portion at a starting point and the position and the posture of the distal end portion at an ending point are interpolated with a straight line. MoveS indicates that the position and posture of the distal end portion at the starting point and the position and posture of the distal end portion at the ending point are interpolated with an S-shaped curve. MoveJ indicates that the angle of each axis at the starting point and the angle of each axis at the ending point are interpolated with a straight line. Examples of the auto command include MoveAuto.

According to the plurality of commands including the move command and the auto command, the operation path including the predefined segment (move segment) corresponding to the move command and the undefined segment corresponding to the auto command is represented.

The path generation element 300 generates an additional path for the undefined segment corresponding to the auto command. For example, the path generation element 300 generates the via point (arrival point) of the auto command and the additional path from a previous via point (start point) to the arrival point. Note that, in a case where the auto command is at the head of the plurality of commands, or the like, the path generation element 300 may generate the additional path with a current position of the distal end portion of the industrial robot 200 as the start point.

The robot control element 600 operates the industrial robot 200 based on the plurality of commands and the additional path. For example, the robot control element 600 operates the industrial robot 200 along a series of operation paths including a plurality of move segment paths respectively corresponding to the plurality of move commands and one or more additional paths respectively corresponding to the one or more auto commands.

The robot control element 600 does not need to operate the industrial robot 200 to completely follow each of the plurality of move segment paths and the one or more additional paths, and is only required to operate the industrial robot 200 to at least partially follow each of the plurality of move segment paths and the one or more additional paths partially. For example, the robot control element 600 may operate the industrial robot 200 to at least partially follow each of the plurality of move segment paths and the one or more additional paths, while not passing through one or more via points of the operation path.

When the robot control element 600 is operating the industrial robot 200 based on one command, the path generation element 300 generates the additional path based on the interference region information updated by the interference region update element 500 and the monitoring condition 402. For example, when the robot control element 600 is operating the industrial robot 200 based on the move command, the path generation element 300 generates the additional path up to the arrival point in the undefined segment corresponding to the auto command, based on the auto command after the move command, the updated information regarding the interference region, and the monitoring condition 402. For example, when the robot control element 600 is operating the industrial robot 200 along the move segment path corresponding to the move command, the path generation element 300 generates the additional path. When the robot control element 600 is operating the industrial robot 200 along the move segment path corresponding to the move command that is two or more commands before the auto command, the path generation element 300 may generate the additional path.

When the robot control element 600 is operating the industrial robot 200 based on the preceding auto command, the path generation element 300 may generate the additional path for the undefined segment corresponding to the subsequent auto command, based on the subsequent auto command, the updated information regarding the interference region, and the monitoring condition 402. When the robot control element 600 is operating the industrial robot 200 based on the auto command that is two or more commands before the subsequent auto command, the path generation element 300 may generate the additional path for the undefined segment corresponding to the subsequent auto command, based on the subsequent auto command, the updated information regarding the interference region, and the monitoring condition 402.

For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region and whether or not the industrial robot 200 satisfies the monitoring condition 402. For example, the path generation element 300 may store model information of the industrial robot 200 in advance, simulate the operation of the industrial robot 200 by using the model information, and check whether or not the industrial robot 200 interferes with the interference region and whether or not the industrial robot 200 satisfies the monitoring condition 402. The model information may include numerical information specifying a structure and a size. For example, the path generation element 300 may determine whether or not the industrial robot 200 interferes with the interference region and whether or not the industrial robot 200 satisfies the monitoring condition 402 by specifying each joint position in the three-dimensional space according to the link length of the industrial robot 200 or the like, calculating the robot region by connecting the joint positions by the model of the industrial robot 200, and comparing the robot region with the interference region.

When it is determined that the industrial robot 200 interferes with the interference region or that the industrial robot 200 does not satisfy the monitoring condition 402, the path generation element 300 randomly generates one via point that does not cause the interference with the interference region and allows the monitoring condition 402 to be satisfied, and adds the via point between the start point and the arrival point. Thereafter, the generation and addition of the via point are repeated until the additional path connecting the start point, the generated one or more via points, and the arrival point no longer causes the interference between the industrial robot 200 and the interference region and allows the industrial robot 200 to satisfy the monitoring condition 402. Accordingly, it is possible to generate the additional path that maintains a state where the interference with the interference region does not occur and the monitoring condition 402 is satisfied.

### (Generation of Additional Path in Consideration of Each-Axis Operation-Region Limitation)

When the monitoring condition 402 includes information regarding an allowable range of the angle of each axis of the industrial robot 200, the path generation element 300 generates the additional path such that the industrial robot 200 does not interfere with the interference region indicated by the information regarding the interference region included in the path generation element 300 and the angle of each axis of the industrial robot 200 does not exceed the allowable range. For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region and whether or not the angle of each axis of the industrial robot 200 falls within the allowable range. When it is determined that the industrial robot 200 interferes with the interference region or that the angle of any axis does not fall within the allowable range, the path generation element 300 randomly generates one via point that does not cause the interference with the interference region and allows the angle of each axis of the industrial robot 200 to fall within the allowable range in movement from the start point, and adds the via point between the start point and the arrival point. Thereafter, the generation and addition of the via point are repeated until the additional path connecting the start point, the generated one or more via points, and the arrival point no longer causes the interference between the industrial robot 200 and the interference region and allows the angle of each axis of the industrial robot 200 to fall within the allowable range. Accordingly, it is possible to generate the additional path that maintains a state where the interference with the interference region does not occur and the angle of each axis of the industrial robot 200 falls within the allowable range. When the monitoring condition 402 includes information regarding the coasting amount, the path generation element 300 may further use the information regarding the coasting amount to generate the additional path.

### (Generation of Additional Path in Consideration of Each-Axis Speed Monitoring)

When the monitoring condition 402 includes information regarding an upper limit of the operation speed of each axis of the industrial robot 200, the path generation element 300 generates the additional path such that the industrial robot 200 does not interfere with the interference region indicated by the information regarding the interference region included in the path generation element 300 and the operation speed of each axis of the industrial robot 200 does not exceed the upper limit. For example, on a condition that the operation speed of each axis of the industrial robot 200 does not exceed the upper limit, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region. When it is determined the industrial robot 200 interferes with the interference region, the path generation element 300 randomly generates one via point that does not cause the interference with the interference region, and adds the via point between the start point and the arrival point. Thereafter, the generation and addition of the via point are repeated until the additional path connecting the start point, the generated one or more via points, and the arrival point no longer causes the interference between the industrial robot 200 and the interference region. Accordingly, it is possible to generate the additional path that maintains a state where the interference with the interference region does not occur and the operation speed of each axis of the industrial robot 200 falls below the upper limit.

### (Generation of Additional Path in Consideration of Out-of-Region Monitoring)

When the monitoring condition 402 includes information regarding the interference region of the industrial robot 200, the path generation element 300 generates the additional path such that the industrial robot 200 does not interfere with an interference region (may be described as a first interference region) indicated by the information regarding the interference region included in the path generation element 300 and the industrial robot 200 does not interfere with an interference region (may be described as a second interference region) indicated by the information regarding the interference region included in the monitoring condition 402. The first interference region includes one or more interference regions. The second interference region includes one or more interference regions. For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the first interference region and whether or not the industrial robot 200 interferes with the second interference region. When it is determined that the industrial robot 200 interferes with the first interference region or interferes with the second interference region, the path generation element 300 randomly generates one via point that does not cause the interference with the first interference region and does not cause the interference with the second interference region, and adds the via point between the start point and the arrival point. Thereafter, the generation and addition of the via point are repeated until the additional path connecting the start point, the generated one or more via points, and the arrival point no longer causes the interference between the industrial robot 200 and the first interference region and the interference between the industrial robot 200 and the second interference region. Accordingly, it is possible to generate the additional path that maintains a state where the interference with the first interference region does not occur and the interference with the second interference region does not occur. When the monitoring condition 402 includes the information regarding the coasting amount, the path generation element 300 may further use the information regarding the coasting amount to generate the additional path. When the information regarding the coasting amount is included in the monitoring condition 402, the path generation element 300 may generate the additional path without using the information regarding the coasting amount, and the robot control element 600 may execute the control of the industrial robot 200 by using the additional path generated by the path generation element 300 and the information regarding the coasting amount. For example, the robot control element 600 adjusts the speed of the industrial robot 200 such that the position after coasting does not cause the interference with the first interference region and the second interference region, while operating the industrial robot 200 according to the additional path generated by the path generation element 300. That is, the robot control element 600 may ensure that the position after coasting does not cause the interference with the first interference region and the second interference region by adjusting the speed on the additional path generated by the path generation element 300.

(when Multiple Interference Regions are Present)

When the monitoring condition 402 includes information regarding a plurality of interference regions of the industrial robot 200, the path generation element 300 may specify a merge region including the plurality of interference regions and generate the operation path such that the industrial robot 200 does not interfere with the first interference region and does not interfere with the merge region.

(Generation of Additional Path in Consideration of in-Region Monitoring)

When the monitoring condition 402 includes information regarding the operation region of the industrial robot 200, the path generation element 300 generates the additional path such that the industrial robot 200 does not interfere with the interference region indicated by the information regarding the interference region included in the path generation element 300 and the industrial robot 200 does not leave the operation region. For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region and whether or not the industrial robot 200 leaves the operation region. When it is determined that the industrial robot 200 interferes with the interference region or leaves the operation region, the path generation element 300 randomly generates one via point that does not cause the interference with the interference region and is included in the operation region, and adds the via point between the start point and the arrival point. Thereafter, the generation and addition of the via point are repeated until the additional path connecting the start point, the generated one or more via points, and the arrival point no longer causes the interference between the industrial robot 200 and the interference region and no longer allows the industrial robot 200 to leave the operation region. Accordingly, it is possible to generate the additional path that maintains a state where the industrial robot 200 does not interfere with the interference region and does not leave the operation region. When the monitoring condition 402 includes the information regarding the coasting amount, the path generation element 300 may further use the information regarding the coasting amount to generate the additional path.

### (Generation of Additional Path in Consideration of Plane Monitoring)

When the monitoring condition 402 includes information regarding a plane of the plane monitoring of the industrial robot 200, the path generation element 300 generates the additional path such that the industrial robot 200 does not interfere with the interference region indicated by the information regarding the interference region included in the path generation element 300 and the industrial robot 200 does not leave the safety region. For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region and whether or not the industrial robot 200 leaves the safety region. When it is determined that the industrial robot 200 interferes with the interference region or leaves the safety region, the path generation element 300 randomly generates one via point that does not cause the interference with the interference region and is included in the safety region, and adds the via point between the start point and the arrival point. Thereafter, the generation and addition of the via point are repeated until the additional path connecting the start point, the generated one or more via points, and the arrival point no longer causes the interference between the industrial robot 200 and the interference region and no longer allows the industrial robot 200 to leave the safety region. Accordingly, it is possible to generate the additional path that maintains a state where the industrial robot 200 does not interfere with the interference region and does not leave the safety region. When the monitoring condition 402 includes the information regarding the coasting amount, the path generation element 300 may further use the information regarding the coasting amount to generate the additional path.

### (Generation of Additional Path in Consideration of Speed Limitation)

When the monitoring condition 402 includes the upper limit value of the TCP speed and the upper limit value of the FCP speed of the industrial robot 200, the path generation element 300 generates the additional path such that the industrial robot 200 does not interfere with the interference region indicated by the information regarding the interference region included in the path generation element 300 and the TCP speed and the FCP speed of the industrial robot 200 do not exceed the upper limit values. For example, on a condition that the TCP speed and the FCP speed of the industrial robot 200 do not exceed the upper limit values, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region. When it is determined the industrial robot 200 interferes with the interference region, the path generation element 300 randomly generates one via point that does not cause the interference with the interference region, and adds the via point between the start point and the arrival point. Thereafter, the generation and addition of the via point are repeated until the additional path connecting the start point, the generated one or more via points, and the arrival point no longer causes the interference between the industrial robot 200 and the interference region. Accordingly, it is possible to generate the additional path that maintains a state where the interference with the interference region does not occur and the TCP speed and the FCP speed of the industrial robot 200 do not exceed the upper limit values.

### (Generation of Additional Path in Consideration of Tool Angle Monitoring)

When the monitoring condition 402 includes the reference value and the limit angle of the inclination of the tool attached to the industrial robot 200, the path generation element 300 generates the additional path such that the industrial robot 200 does not interfere with the interference region indicated by the information regarding the interference region included in the path generation element 300 and the angle of the tool of the industrial robot 200 relative to the reference value does not exceed the limit angle. For example, the path generation element 300 first interpolates the start point and the arrival point with a straight line to temporarily generate an additional path, simulates the operation of the industrial robot 200 based on the temporarily generated additional path, and checks whether or not the industrial robot 200 interferes with the interference region and whether or not the angle of the tool relative to the reference value exceeds the limit angle. When it is determined that the industrial robot 200 interferes with the interference region or that the angle of the tool exceeds the limit angle, the path generation element 300 randomly generates one via point that does not cause the interference with the interference region and allows the angle of the tool relative to the reference value to fall within the limit angle in the movement from the start point, and adds the via point between the start point and the arrival point. Thereafter, the generation and addition of the via point are repeated until the additional path connecting the start point, the generated one or more via points, and the arrival point no longer causes the interference between the industrial robot 200 and the interference region and no longer allows the angle of the tool relative to the reference value to exceed the limit angle. Accordingly, it is possible to generate the additional path that maintains a state where the interference with the interference region does not occur and the angle the tool relative to the reference value does not exceed the limit angle.

### (Generation of Additional Path in Consideration of Plurality of Types of Functional Safety Functions)

When the monitoring condition 402 includes information regarding a plurality of types of functional safety functions, the path generation element 300 may generate the additional path such that the industrial robot 200 does not interfere with the interference region indicated by the information regarding the interference region included in the path generation element 300 and all conditions of the plurality of types of functional safety functions are satisfied.

### (Independence of Autonomous Control Unit)

The autonomous control unit 36 may be a computing device independent of the robot controller 30. For example, the autonomous control unit 36 may be implemented by a personal computer (PC) or the like having more resources and higher processing capability than a so-called robot controller.

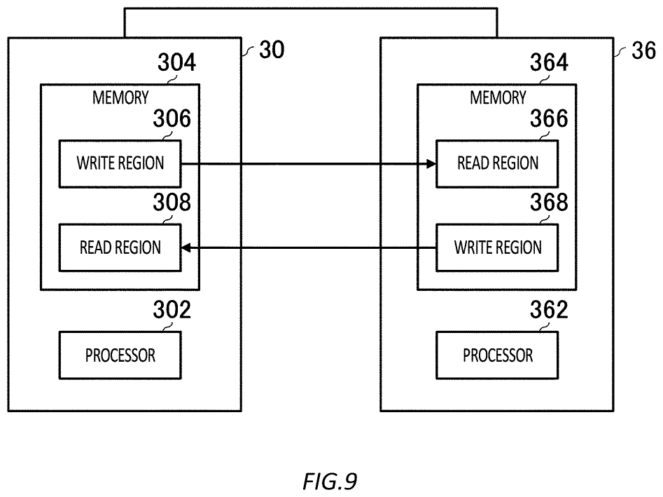

FIG. 9 schematically shows an example of a hardware configuration of the robot controller 30 and the autonomous control unit 36. The robot controller 30 includes a processor 302 and a memory 304 in which state information and the monitoring condition 402 of the industrial robot 200 are stored, and the autonomous control unit 36 includes a memory 364 a content of which is synchronized with that of the memory 304, and a processor 362 capable of executing an application that performs a computation related to the control of the industrial robot 200 based on the content of the memory 364.

Since the memory 304 and the memory 364 are synchronized with each other, it is possible to create an application of the path generation element 300 or the like, which is related to the control of the industrial robot 200, using the memory 364 as a data writing or reading partner. Therefore, the application can be easily constructed without considering special rules such as a protocol of data exchange between the robot controller 30 and the autonomous control unit 36.

The robot controller 30 and the autonomous control unit 36 may be provided in housings different from each other. The robot controller 30 and the autonomous control unit 36 may be provided in a same housing as long as they are independent from each other. Examples of communication performed by the robot controller 30 and the autonomous control unit 36 include serial communication, parallel communication, bus communication, and the like.

The communication performed by the robot controller 30 and the autonomous control unit 36 may be network communication. The network communication is communication performed by a communication protocol in a network communication line. The communication protocol in the network communication line includes specifying a network address of a partner each time data is transmitted.

The network communication may be industrial network communication that ensures time synchronization, or may be general-purpose local area network (LAN) communication or wide area network (WAN) communication. The robot controller 30 and the autonomous control unit 36 may be configured to perform wireless communication by wireless LAN, mobile communication (for example, 5G communication), or the like.

The memory 304 may be constituted by one or more memory devices, one or more storage devices, or the like. The memory 364 may be constituted by one or more memory devices, one or more storage devices, or the like. The memory 304 may have a write region 306 for writing data and a read region 308 for reading data. The memory 364 may have a read region 366 for reading data and a write region 368 for writing data.

A content of the read region 366 is synchronized with a content of the write region 306. Therefore, the content written in the write region 306 in the robot controller 30 can be read from the read region 366 in the autonomous control unit 36. A content of the read region 308 is synchronized with a content of the write region 368. Therefore, the content written in the write region 368 in the autonomous control unit 36 can be read from the read region 308 in the robot controller 30.

The robot controller 30 may transmit the content of the write region 306 to the autonomous control unit 36 at a constant cycle by network communication. The autonomous control unit 36 may transmit the content of the write region 368 to the robot controller 30 at a constant cycle by network communication. Note that, even a case where a slight variation occurs in a synchronization cycle of the memory 304 and the memory 364 due to communication jitter or the like is included in constant-cycle synchronization as long as a constant periodicity is generally maintained. The memory 304 and the memory 364 are mutually updated at a constant cycle by network communication. Therefore, an application can be easily constructed without being conscious of a protocol of network communication or the like. The autonomous control unit 36 may issue a movement instruction to the robot controller 30 side, based on a result of calculation by the path generation element 300.

### Application Example

In the example shown in FIG. 8, the path generation element 300 is arranged in the autonomous control unit 36, and the monitoring element 400 and the monitoring condition 402 are arranged in the functional safety unit 34, but the present invention is not limited thereto.

For example, the path generation element 300 may be arranged in the autonomous control unit 36, and the monitoring element 400 and the monitoring condition 402 may be arranged in the robot control unit 32. In this case, the robot controller 30 may not include the functional safety unit 34. When the robot control unit 32 controls the industrial robot 200, the path generation element 300 arranged in the autonomous control unit 36 may generate the operation path of the industrial robot 200 by using the monitoring condition 402 used for monitoring the industrial robot 200.

For example, the path generation element 300 and the interference region update element 500 may be arranged in the robot control unit 32, and the monitoring element 400 and the monitoring condition 402 may be arranged in the functional safety unit 34. In this case, the robot controller 30 may not include the autonomous control unit 36. The path generation element 300 arranged in the robot control unit 32 may use the monitoring condition 402 used for monitoring by the monitoring element 400 of the functional safety unit 34 when generating the operation path of the industrial robot 200 during runtime or generating the operation path of the industrial robot 200 during non-runtime.

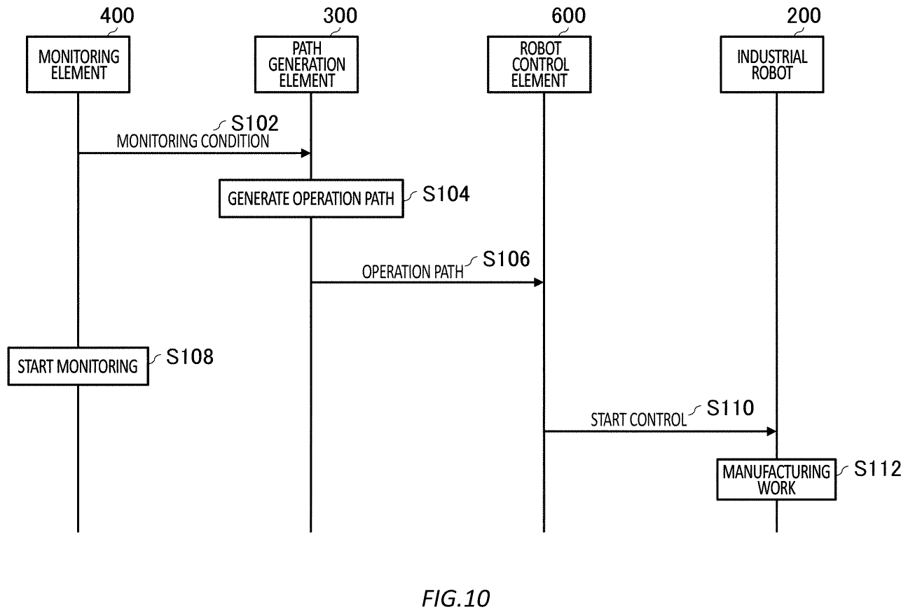

FIG. 10 schematically shows an example of a flow in which the system 10 performs manufacturing processing of an object to be manufactured. For example, the system 10 may manufacture an object to be manufactured, by performing machining on a workpiece. For example, when the robot controller 30 controls the industrial robot 200, the industrial robot 200 performs, on the workpiece, arbitrary work such as machining and assembly. The workpiece may be a one-piece part, a semi-finished product obtained by combining a plurality of parts, or a product obtained by combining a plurality of parts. As the object to be manufactured, any article that undergoes machining by the industrial robot 200 may be applicable.

In step (a step may be abbreviated as S) 102, the path generation element 300 acquires the monitoring condition 402 used by the monitoring element 400. In S104, the path generation element 300 generates the operation path of the industrial robot 200 by using the monitoring condition 402 acquired in S102. The path generation element 300 uses the information regarding the interference region included in the path generation element 300 and the monitoring condition 402 to generate the operation path that maintains a state where the industrial robot 200 does not interfere with the interference region and the monitoring condition 402 is satisfied. In S106, the path generation element 300 transmits the generated operation path to the robot control element 600.

In S108, the monitoring element 400 starts monitoring the industrial robot 200 based on the monitoring condition 402. In S110, the robot control element 600 starts the control of the industrial robot 200 by using the operation path acquired in S106. The robot control element 600 controls the industrial robot 200 to operate according to the operation path. Accordingly, a work of the industrial robot 200 manufacturing the object to be manufactured is started (S112).

In S112, the industrial robot 200 acquires a workpiece to be machined. The industrial robot 200 machines the acquired workpiece. The path generation element 300 may generate the operation path in real time by using the information regarding the interference region updated by the interference region update element 500. When the manufacturing of the object to be manufactured is ended, the processing is ended.

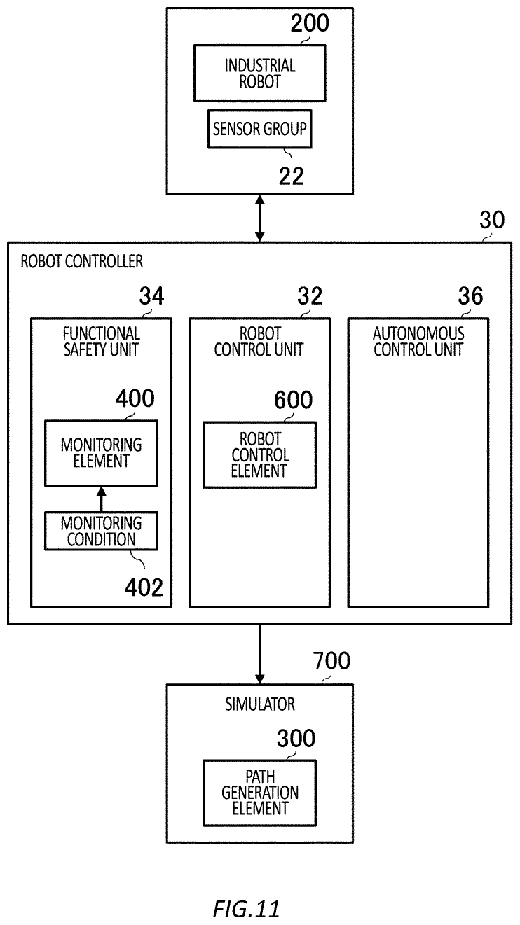

FIG. 11 schematically shows another example of a configuration of the system 10. Here, differences from the system 10 shown in FIG. 8 will be mainly described. The system 10 shown in FIG. 11 includes the robot controller 30 that controls the industrial robot 200 and a simulator 700. The robot controller 30 includes the robot control unit 32, the functional safety unit 34, and the autonomous control unit 36.

The simulator 700 executes a simulation related to the industrial robot 200. The simulator 700 includes the path generation element 300. The path generation element 300 simulates the operation path of the industrial robot 200 during non-runtime.

In a conventional simulator, the operation path of the industrial robot 200 is simulated by using the information regarding the interference region included in the path generation element 300 of the industrial robot 200. However, when the monitoring condition 402 used by the monitoring element 400 is not taken into consideration when the industrial robot 200 actually operates, there is a possibility that the industrial robot 200 does not satisfy the monitoring condition 402 when the industrial robot 200 actually operates using the operation path generated by the simulation.

The path generation element 300 included in the simulator 700 according to the present embodiment uses the monitoring condition 402 used by the monitoring element 400 to generate the operation path of the industrial robot 200 by simulation. Accordingly, also in the simulation, it is possible to generate the operation path in consideration of the monitoring condition 402 used when the industrial robot 200 actually operates.

### Application Example

In the example shown in FIG. 11, the monitoring element 400 and the monitoring condition 402 are arranged in the functional safety unit 34, but the present invention is not limited thereto. For example, the monitoring element 400 and the monitoring condition 402 may be arranged in the robot control unit 32. In this case, the robot controller 30 may not include the functional safety unit 34. When the robot control unit 32 controls the industrial robot 200, the path generation element 300 arranged in the simulator 700 may generate the operation path of the industrial robot 200 by using the monitoring condition 402 used for monitoring the industrial robot 200.

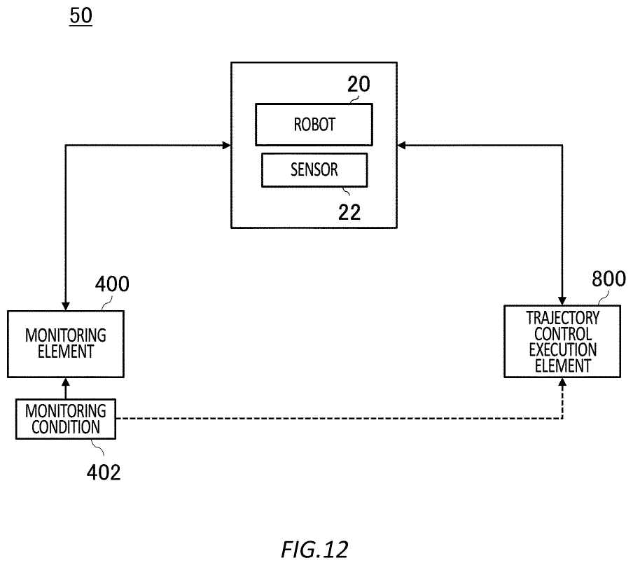

FIG. 12 schematically shows an example of a system 50. The system 50 includes the monitoring element 400. The system 50 includes a trajectory control execution element 800. The system 50 may include the robot 20. The system 50 may include the sensor group 22.

The trajectory control execution element 800 executes trajectory control of the robot 20. For example, the trajectory control execution element 800 controls the robot 20 so as to operate the robot 20 along a trajectory indicated by the operation path according to the operation path of the robot 20 acquired in advance.

The trajectory control execution element monitors that the robot 20 satisfies the monitoring condition 402, and when it is predicted that the robot 20 does not satisfy the monitoring condition 402, the trajectory control execution element 800 may execute the trajectory control of the robot 20 by using the monitoring condition 402 used by the monitoring element 400 having the safety function of shutting off the power supply to the motor of the robot 20.

Although a safety function of the trajectory control execution element 800 can allow the robot 20 to satisfy the monitoring condition 402, when the power supply to the motor is suddenly shut off during the operation of the robot 20 so as to stop the robot 20, there is a possibility that a large load is applied, an accuracy of subsequent control is reduced due to a difference between a set state and an actual state, or the life is shortened or a failure occurs due to damage to the motor or the axis. On the other hand, the trajectory control execution element 800 can acquire and use the monitoring condition 402 used by the monitoring element 400 to allow the robot 20 to satisfy the monitoring condition 402, thereby reducing such a possibility.

When the monitoring condition 402 includes the information regarding the interference region of the robot 20 and the coasting amount information regarding the coasting amount of the robot 20 when the power supply to the motor of the robot 20 is shut off during the operation of the robot 20, the monitoring element 400 may have the safety function in which the position that the robot 20 reaches by coasting when the power supply to the motor of the robot 20 is shut off at a future timing of the robot 20 is predicted based on the value related to the robot 20 and the coasting amount information, and the power supply to the motor of the robot 20 is shut off when the predicted position is included in the interference region. Then, the trajectory control execution element 800 may execute the trajectory control of the robot 20 by using the information regarding the interference region included in the monitoring condition 402 and the coasting amount information.

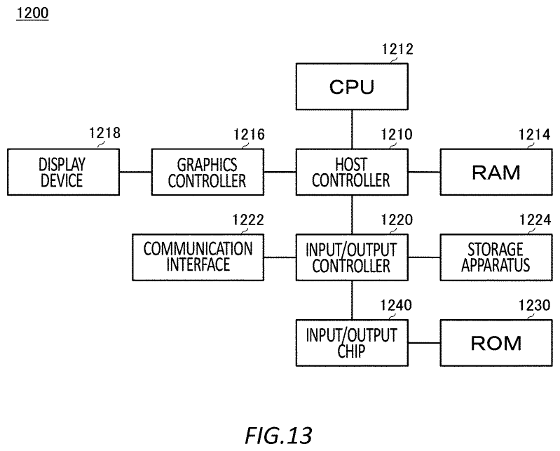

FIG. 13 schematically shows an example of a hardware configuration of a computer 1200 functioning as the robot controller 30, the robot control unit 32, the functional safety unit 34, the autonomous control unit 36, or the simulator 700. A program installed in the computer 1200 can cause the computer 1200 to function as one or more “sections” and/or “elements” of the apparatus according to the present embodiment or cause the computer 1200 to perform an operation associated with an apparatus according to the present embodiment or the one or more “sections” and/or “elements”, and/or can cause the computer 1200 to perform a process according to the present embodiment or steps of the process. Such a program may be executed by a CPU 1212 to cause the computer 1200 to perform particular operations associated with some or all of the blocks in the flowcharts and block diagrams described in the present specification. The CPU 1212 may be a multi-CPU.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage apparatus 1224, a DVD drive and an IC card drive, which are connected to the host controller 1210 via an input/output controller 1220. The DVD drive may be a DVD-ROM drive, a DVD-RAM drive, etc. The storage apparatus 1224 may be a hard disk drive, a solid-state drive, and the like. The computer 1200 also includes a ROM 1230 and a legacy input/output unit such as a keyboard, which are connected to the input/output controller 1220 via an input/output chip 1240.

The CPU 1212 operates in accordance with the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with other electronic devices via a network. The storage apparatus 1224 stores a program and data used by the CPU 1212 in the computer 1200. The DVD drive reads the programs or the data from the DVD-ROM or the like, and provides the storage apparatus 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer-readable storage medium such as the DVD-ROM or the IC card. The program is read from the computer-readable storage medium, installed into the storage apparatus 1224, RAM 1214, or ROM 1230, which are also examples of a computer-readable storage medium, and executed by the CPU 1212. Information processing written in these programs is read by the computer 1200, and provides cooperation between the programs and the various types of hardware resources described above. An apparatus or method may be configured by implementing the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage apparatus 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive (DVD-ROM), the IC card, etc., and perform various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the said plurality of entries, and read the attribute value of the second attribute stored in the said entry, thereby obtaining the attribute value of the second attribute associated with the first attribute that satisfies a predetermined condition.

The above described program or software modules may be stored in the computer-readable storage medium on or near the computer 1200. In addition, a recording medium such as a hard disk or a RAM provided in a server system connected to a dedicated communication network or the Internet can be used as the computer-readable storage medium, thereby providing the program to the computer 1200 via the network.

The blocks in the flowcharts and block diagrams in this embodiment may represent steps in the process in which an operation is executed or “sections” and/or elements of an apparatus that are responsible for executing the operation. Certain steps and “sections” and/or elements may be implemented by a dedicated circuit, a programmable circuit provided with computer-readable instructions stored on the computer-readable storage medium, and/or a processor provided with the computer-readable instructions stored on the computer-readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer-readable storage medium may include any tangible device capable of storing an instruction executed by an appropriate device, so that the computer-readable storage medium having the instruction stored thereon constitutes a product including an instruction that may be executed in order to provide means for executing an operation designated by a flowchart or a block diagram. An example of the computer-readable storage medium may include an electronic storage medium, a magnetic storage medium, an optical storage medium, an electromagnetic storage medium, a semiconductor storage medium, etc. A more specific example of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as Smalltalk (registered trademark), JAVA (registered trademark), and C++, or the like, and a conventional procedural programming language such as a “C” programming language or a similar programming language.

The computer-readable instruction may be provided for a processor or programmable circuitry of a programmable data processing apparatus, such as a computer, locally or via a local area network (LAN), a wide area network (WAN) such as the Internet, or the like to execute the computer-readable instruction in order to create means for executing the operations specified in the flowcharts or block diagrams.

Here, the computer may be a computer such as a personal computer (PC), a tablet computer, smartphone, a work station, a server computer, or a general purpose computer, or may be a computer system in which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. In addition, which portion of the program each of the plurality of processors is to execute may be statically determined by multi-processor aware programming.

While the present invention has been described by way of the embodiments, the technical scope of the present invention is not limited to the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: system; 20: robot; 22: sensor group; 30: robot controller; 32: robot control unit; 34: functional safety unit; 36: autonomous control unit; 50: system; 200: industrial robot; 210: S axis; 220: L axis; 230: U axis; 240: R axis; 250: B axis; 260: T axis; 300: path generation element; 302: processor; 304: memory; 306: write region; 308: read region; 312: interference region; 314: interference region; 320: operation path; 322: via point; 330: monitoring condition acquisition element; 362: processor; 364: memory; 366: read region; 368: write region; 400: monitoring element; 402: monitoring condition; 412, 422, 424, 426: interference region; 432: merge region; 500: interference region update element; 600: robot control element; 700: simulator; 800: trajectory control execution element; 1200: computer; 1210: host controller; 1212: CPU; 1214: RAM; 1216: graphics controller; 1218: display device; 1220: input/output controller; 1222: communication interface; 1224: storage apparatus; 1230: ROM; and 1240: input/output chip.

What is claimed is:

1. A system comprising:
a monitoring element which monitors a robot during runtime, based on a monitoring condition; and
a path generation element which generates an operation path of the robot by using the monitoring condition used by the monitoring element.

2. The system according to claim 1, wherein
the path generation element
includes information regarding an interference region in a vicinity of the robot, and
generates the operation path by using the monitoring condition in addition to the interference region.

3. The system according to claim 2, further comprising
an interference region update element which updates the information regarding the interference region, based on real-time sensing information from a sensor, wherein
the path generation element generates the operation path by using the information, which is updated, regarding the interference region and the monitoring condition.

4. The system according to claim 2, wherein
the monitoring condition includes information regarding an interference region of the robot, and
the path generation element generates the operation path such that the robot does not interfere with the interference region indicated by the information regarding the interference region included in the path generation element and the robot does not interfere with the interference region indicated by the information regarding the interference region included in the monitoring condition.

5. The system according to claim 4, wherein
the monitoring condition includes coasting amount information regarding a coasting amount of the robot when power supply to a motor of the robot is shut off during an operation of the robot,
the monitoring element has a safety function in which a position that the robot reaches by coasting when the power supply to the motor of the robot is shut off at a future timing of the robot is predicted based on a value related to the robot and the coasting amount information and the power supply to the motor of the robot is shut off when the position predicted is included in the interference region indicated by the information regarding the interference region included in the monitoring condition, and
the path generation element generates the operation path such that, at each timing of the operation path, the position that the robot reaches by coasting when the power supply to the motor of the robot is shut off is not included in the interference region indicated by the information regarding the interference region included in the monitoring condition.

6. The system according to claim 1, wherein
the monitoring element has a function of using a plurality of monitoring conditions while switching between the monitoring conditions, and
the path generation element generates the operation path by using the monitoring condition, which is used by the monitoring element when generating the operation path, among the plurality of monitoring conditions.

7. The system according to claim 6, wherein the monitoring element uses the plurality of monitoring conditions while switching between the monitoring conditions based on sensing information from a sensor.

8. The system according to claim 1, comprising:
a first unit which includes the monitoring element; and
a second unit which includes the path generation element.

9. The system according to claim 8, further comprising the robot.

10. The system according to claim 8, wherein
the first unit is a computing device which includes one or more first processors and a first memory and is independently operable, and
the second unit is a computing device which includes one or more second processors and a second memory and is independently operable.

11. The system according to claim 10, wherein
the monitoring element is implemented by the one or more first processors, and
the path generation element is implemented by the one or more second processors.

12. The system according to claim 11, wherein
the first memory stores the monitoring condition, and
the second memory is synchronized in content with the first memory.

13. The system according to claim 12, wherein
the first memory has a first write region for writing data and a first read region for reading data,
the second memory has a second write region for writing data and a second read region for reading data,
the first unit transmits a content of the first write region to the second unit at a constant cycle by network communication, and
the second unit transmits a content of the second write region to the first unit at a constant cycle by network communication.

14. The system according to claim 8, wherein
the first unit includes a robot control element which controls the robot, and
the robot control element operates the robot according to the operation path generated by the path generation element.

15. The system according to claim 8, wherein the second unit gives an order to the robot based on the operation path generated by the path generation element.

16. The system according to claim 8, further comprising
a third unit which includes a robot control element which controls the robot, wherein
the robot control element operates the robot according to the operation path generated by the path generation element.

17. A unit comprising:
a monitoring condition acquisition element which acquires a monitoring condition used by a monitoring element having a function of monitoring a robot during runtime based on the monitoring condition; and
a path generation element which generates an operation path of the robot by using the monitoring condition.

18. A system comprising:
a monitoring element which has a safety function of monitoring that a robot satisfies a monitoring condition and shutting off power supply to a motor of the robot when it is predicted that the robot does not satisfy the monitoring condition; and
a trajectory control execution element which executes trajectory control of the robot by using the monitoring condition.

19. The system according to claim 18, wherein
the monitoring condition includes information regarding an interference region of the robot and coasting amount information regarding a coasting amount of the robot when the power supply to the motor of the robot is shut off during an operation of the robot,
the monitoring element has the safety function in which a position that the robot reaches by coasting when the power supply to the motor of the robot is shut off at a future timing of the robot is predicted based on a value related to the robot and the coasting amount information and the power supply to the motor of the robot is shut off when the position predicted is included in the interference region, and
the trajectory control execution element executes trajectory control of the robot by using the information regarding the interference region and the coasting amount information.

20. A manufacturing method of manufacturing, by a robot, an object to be manufactured, the manufacturing method comprising:
acquiring, by a path generation element, a monitoring condition used by a monitoring element which monitors the robot during runtime, based on the monitoring condition;
generating a path by the path generation element generating an operation path of the robot by using the monitoring condition;
starting, by the monitoring element, monitoring the robot based on the monitoring condition; and
controlling the robot based on the operation path generated in the generating the path.
